(19) United States
(12) Patent Application Publication
(10) Pub. No.: US 2010/0087604 A1
(43) Pub. Date: Apr. 8, 2010

(54) SPLITTABLE CONJUGATE FIBER AND METHOD FOR PRODUCING THE SAME

(75) Inventors: Keita Katsuma, Osaka (JP); Masanobu Miyata, Fukui (JP)

Correspondence Address: Kirschstein, Israel, Schiffmiller & Pieroni, P.C., 425 FIFTH AVENUE, 5TH FLOOR, NEW YORK, NY, 10016-2223, US

(73) Assignee: KB SEIREN, LTD., Fukui (JP)

(21) Appl. No.: 12/597,581

(22) PCT Filed: May 10, 2007
(86) PCT No.: PCT/JP2007/059676

§ 371 Date: Oct. 26, 2009

(51) Int. Cl. C08L 77/00; D01F 8/14; D01D 5/10; D01F 8/12

(52) U.S. Cl. 525/420; 264/172.18

(57) ABSTRACT

A splittable conjugate fiber that even in the polishing of precision equipments, such as a hard disc, is free from injuring of polishing object parts and allows precision polishing. The splittable conjugate fiber is one composed of, containing substantially none of titanium dioxide, a polyester component and a polyamide component, characterized in that the cyclic trimer content of the polyester component is less than 1.0%. Preferably, this product is produced under conditions such that the difference between polyester-containing cyclic trimer after melt extrusion and cyclic trimer of polyester pellet as a raw material is less than 0.3%.

### TECHNICAL FIELD

The present invention relates to a splittable conjugate fiber and a method for producing the same. More particularly, the present invention relates to a splittable conjugate fiber suitable for cleaning tools such as a wiping cloth, especially for polishing or cleaning precision instruments, such as a hard disk, precisely without scratching the items to be polished or cleaned, and to a method for producing the same.

### BACKGROUND ART

Conventionally, in applications for polishing electronic components have been used, for example, artificial leather prepared by using a nonwoven fabric of polyester or the like as aground fabric and impregnating the surface thereof with an urethane resin or the like as a grain, or a polishing cloth prepared by forming a fabric from a conjugate fiber of polyester and/or polyamide or the like and then splitting the fabric into microfibers.

For example, hard disks or the like have recently been coming to have increased capacities and there are products of 100 GB or more. These have shifted from conventional hard disks made of aluminum to those made of glass and the reduction in size of hard disks has also proceeded greatly; in order to achieve the increase in capacity and the reduction in size simultaneously, it is necessary to polish disk surfaces precisely.

However, artificial leather is expensive because processing a corresponding ground fabric into microfibers or improving the grain results in an increased production cost.

In contrast to this, microfibers prepared by forming a fabric from a conjugate fiber of, for example, polyester and polyamide as a filament and then performing splitting treatment are inexpensive and have performance suitable for polishing. For example, in patent document 1 is proposed a wiping cloth with a specified count and a specified cover factor suitable for polishing hard disks which is prepared by subjecting a conjugate fiber of polyester and polyamide to splitting treatment, followed by densification.

On the other hand, patent document 2 discloses the use of a polyester resin suitable for bottles which contains no titanium dioxide and contains a cyclic trimer at a low content.
Patent document 1: JP 2000-303300 A
Patent document 2: JP 7-37515 B

### DISCLOSURE OF THE INVENTION

### Problems to be Solved by the Invention

However, the fabrics of patent document 1 have a problem that oligomers including a cyclic trimer contained in polyester are extracted by a solvent, such as acetone or isopropyl alcohol, to be used in polishing or cleaning, resulting in poor polishing/cleaning performance.

Moreover, the splittable conjugate fibers used in these fabrics are produced generally by using a resin containing not a little titanium dioxide as a matting agent which is used for general purpose polyester fibers or polyamide fibers, and in precise polishing of a hard disk, particularly in application for a hard disk made of glass, the titanium dioxide may scratch a glass surface.

In consideration of the use of the polyester resin of patent document 2 for the polyester of patent document 1 in order to solve the above-mentioned problems, this polyester resin is a polyester high in intrinsic viscosity, which is treated by solid phase polymerization, and a high temperature is needed for melt-spinning this resin and a polyamide to be used as a partner component of a conjugate fiber changes in properties at high temperatures; therefore, there is a problem that it is difficult to spin them conjugately.

An object of the present invention is to solve the above-mentioned problems and provide a spinnable, splittable conjugate fiber which releases only a little amount of oligomers when being used for polishing or cleaning as a polishing fabric for glass hard disks and the like and which is suitable for polishing and cleaning without scratching a hard disk surface.

### Means for Solving the Problem

The present inventors have reached the present invention by paying attention to using, as a splittable conjugate fiber for constituting a fabric, a splittable conjugate fiber in which a polyamide is in conjugation with a polyester that is free of a matting agent and that has a reduced content of cyclic trimer contained in a polyester component, in order to prevent unwanted components from being eluted during polishing and to avoid scratching a disk surface.

That is, the product of the present invention is a splittable conjugate fiber which contains substantially no titanium dioxide and which is composed of a polyester component and a polyamide component, wherein the content of a cyclic trimer contained in the polyester component is less than 1.0%.

Moreover, the method of the present invention for producing a splittable conjugate fiber, which is composed of a polyester component and a polyamide component, includes melt-conjugate spinning a polyester chip having a content of a cyclic trimer contained in the polyester component of less than 1.0% with a polyamide, wherein the content difference between the cyclic trimer contained in a polyester after melt extrusion and the cyclic trimer contained in the polyester chip of the raw material is less than 0.3%. In particular, it is preferable to use, as the raw material polyester chip, one prepared by subjecting a polyester chip resulting from melt polycondensation to water-washing treatment with hot water to deactivate the polycondensation catalyst contained in the polyester.

### Effect of the Invention

The splittable conjugate fiber of the present invention can precisely polish a component to be polished without scratching the component even in polishing a precision instrument, such as a hard disk. Moreover, the use of the production method of the present invention leads to reduction in generation of fluff or occurrence of thread breakage in producing a splittable conjugate fiber. Therefore, resulting products are inexpensive and can have stable performance.

### BRIEF DESCRIPTION OF THE DRAWING

FIG. 1 illustrates a cross-section of the splittable conjugate fibers of the present invention.

### BEST MODE FOR CARRYING OUT THE INVENTION

The present invention will be described in detail below. The present invention is directed to a splittable conjugate fiber in which a polyester component and a polyamide component are in conjugation with each other.

As the above-mentioned polyester component, polyesters, such as polyethylene terephthalate, polybutylene terephthalate and polytetramethylene terephthalate, can be used. Particularly, it is preferable to use a polyester which is composed mainly of ethylene terephthalate.

As to the above-mentioned polyester, a desired function can be added, if necessary, by using one which contains a third component copolymerized, including an acid component, such as sodium 5-sulfoisophthalate, adipic acid, sebacic acid and isophthalic acid, and a diol component, such as diethylene glycol, triethylene glycol, polyethylene glycol and cyclohexanedimethanol. However, in order to reduce the content of oligomers such as a cyclic trimer, polyesters with no modification are preferred to polyesters modified by copolymerization of such a third component.

The above-mentioned polyester contains substantially no titanium dioxide. To contain substantially no titanium dioxide means that no titanium oxide is added intentionally during polycondensation, and it is permissible to contain titanium dioxide in a trace amount which is as small as contamination. For example, it is contained at less than 50 ppm as measured by an ordinary ash analysis.

Thus, if substantially no titanium dioxide is contained, a surface is not scratched during polishing or cleaning of a hard disk.

The content of the cyclic trimer of the above-mentioned polyester component is 1.0% or less. In this range, the amount of oligomers eluted by a solvent used in polishing or cleaning of hard disks is small and it is possible to perform polishing and cleaning precisely. If the content is outside that range, a large amount of oligomers are eluted and the oligomers eluted may damage or pollute a disk surface. The cyclic trimer as referred to herein is a deposited cyclic oligomer which deposites on the surface of a resin when polyethylene terephthalate is heated or exposed to vapor of a solvent such as methylene chloride.

The intrinsic viscosity of the polyester, which is not particularly limited, is preferably within a range of 0.55 to 0.65. In this range, because the polyester can be melted at a temperature suitable for conjugate spinning with a polyamide, a good cross-sectional profile is formed and excellent spinning workability tends to be obtained.

The above-mentioned polyester is preferably one to which no solid phase polymerization treatment has been applied. This is because if a resin to which solid phase polymerization has been applied is used, it becomes necessary to perform melt-extrusion at a high temperature, leading to a great decrease in viscosity and the polyamide, which is used as a partner component in a conjugate fiber, degrades greatly at high temperatures, resulting in poor spinning workability.

Incidentally, the polyamide to be used as the polyamide component of the present invention contains substantially no titanium dioxide as in the polyester. This prevents a disk surface from being scratched during polishing or cleaning of a hard disk.

As the above polyamides, there are exemplified such as Nylon 6, Nylon 66, Nylon 4, Nylon 7, Nylon 11, Nylon 12, and polymetaxylene adipamide. Among them, Nylon 6 is preferable because of its general versatility.

The relative viscosity of the polyamide, which is not particularly limited, is preferably 2.5 to 3.2. In this range, it is suitable for composite spinning with a polyester, and it is easy to keep the cross-sectional profile good. The spinning workability also tends to become excellent.

The laterally cross-sectional profile of the splittable conjugate fiber of the present invention is not particularly restricted as long as it is a profile such that the fiber can be split after fabric formation. In a preferable example, a profile such that the single yarn fineness after splitting is uniform is desirable because the polishing performance or the cleaning performance will be excellent.

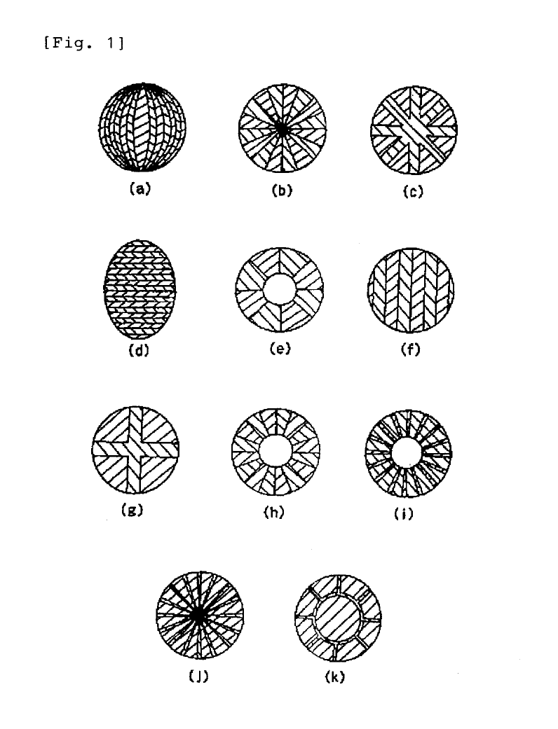

Specific examples thereof are splittable conjugate fibers with a conjugate form having a cross-section shown in FIGS. 1(a) to (k).

For example, the fibers of FIG. 1(a) and FIG. 1(d) are configured so that when they are split, both the two components will be obtained in the form of flat thin fibers. In the fiber of FIG. 1(b), two components are arranged alternately in the form of many fan-shaped segments. In the fibers of FIGS. 1(c), (g) and (j), radial components (radial parts) and fan-shaped components (complementary parts which complement the radial parts) are conjugated. Furthermore, the fibers of FIGS. 1(e), (h) and (i) are examples in which two components are arranged alternately in a loop and have a hollow portion. The fiber of FIG. 1(f) is an example in which two components are conjugated in laterally alternate arrangement. The fiber of FIG. 1(k) is an example in which the fiber is composed of a hollow radial component (radial part) and a circular and trapezoidal component which complement the hollow radial form (complementary parts which complement the radial part). In addition to these, any conjugate form may be applied if each part can be split into a segment.

Especially, the splittable conjugate fibers composed of radial parts and complementary parts complementing the radial parts which are shown in FIG. 1(b) and FIGS. 1(c), (g) and (j) are preferable because such fibers have sharp edges and therefore they are high in polishing performance or cleaning performance.

Examples of combinations of a laterally cross-sectional profile and preferable polymers are given below.

First, splittable conjugate fibers in which a polyester and a polyamide are arranged alternately in a loop and which have a hollow portion shown in FIGS. 1(e), (h) and (i) are preferable because the polyamide is buried as an inner layer and the polyester tends to be exposed to form a surface layer and there is a swell due to the difference in shrinkage factor between the polymers, resulting in a high polishing and cleaning effect.

Furthermore, extremely thin multifilaments derived from splittable conjugate fibers composed of radial parts and complementary parts which complement the radial parts shown in FIGS. 1(c), (g), (j) and (k) wherein the radial parts are made of a polyamide and the complementary parts are made of a polyester are most suitable because the complementary parts are buried as inner layers and the radial parts tend to be exposed to form surface layers and there is a swell due to the difference in shrinkage factor between the polymers, resulting in high polishing performance and high cleaning performance.

As mentioned above, particularly preferred are two-layer-structured yarns which have cross-section forms like those shown in FIGS. 1(c), (e), (g), (h), (i), (j) and (k) composed of a combination of a polyester and a polyamide such that one component may be buried as an inner layer and the other component maybe exposed on the surface after being split and the split will cause the yarns to have swell sufficiently.

The single yarn fineness of the above-mentioned splittable conjugate fiber, which is not limited particularly, is preferably 0.5 to 5. 0 dtex from the viewpoint of excellent spinning workability and suitability for polishing and cleaning. Especially, it is preferably 1.0 to 2.5 dtex.

Next, a concrete method for producing the splittable conjugate fiber of the present invention is described. A polyester chip is obtained by adding ethylene glycol in a molar ratio of 1.02 to 1.8 times to terephthalic acid (this may, if necessary, contain other acid components) to form a slurry, if necessary adding a heat stabilizer, a catalyst, etc., and further subsequently executing polycondensation reaction.

In this operation, the polymerization catalyst is not particularly restricted, but for example, germanium dioxide, antimony trioxide and titanium butoxide can be used. Taking into consideration of color of a resin and the increasing request for being free of antimony, germanium dioxide is preferable.

Subsequently, the polyester chip is subjected to preliminary crystallization treatment. Then, the treated polyester chip is brought into contact with hot water to remove a cyclic trimer. In contacting with hot water, a continuous type or batch type hot water treating apparatus or the like may be used. As to the treating conditions used in this operation, in order to remove acyclic trimer efficiently and to prevent a chip from degrading, it is desirable to bring the chip into contact with hot water at 80 to 100° C. for about 3 hours.

Then, a dehydration-drying treatment is performed to obtain a hot water-treated polyester chip.

Next, the polyester chip is dried to a moisture regain of 20 to 40 ppm.

Then, this polyester chip and a separately dried chip of a polyamide such as Nylon 6 are fed to a composite spinning machine and are each melt-extruded with an extruder, followed by introduction into a spinning head, subsequent melt-discharging through a composite spinneret, and further subsequent winding. Thus, a filament composed of the aforementioned splittable conjugate fiber is obtained.

The spinning and winding method is not particularly restricted. For example, a conventional method in which an undrawn thread is wound up once and then it is drawn in a drawing step, a POY-DT method in which an undrawn thread is taken up at a high speed, wound up without being drawn, and then drawn, a direct spinning drawing method in which a spinning step and a drawing step are combined, and so on, can be used. Among them, the direct spinning drawing method is preferable from the viewpoint of production efficiency.

In order to render the amount of the cyclic trimer contained in the polyester component less than 1.0%, it is desirable to bring a polyester chip into contact with hot water after polycondensation as described above.

The temperature of the hot water used in this operation, which is not particularly limited, is preferably 80 to 100° C. Within this range, deposition of a cyclic trimer from a polyester resin proceeds effectively and further a cleaning effect is obtained. It is more preferably 90 to 98° C. The washing time, which is not also limited particularly, is preferably about 2 to about 5 hours in order to reduce a cyclic trimer efficiently.

It is assumed that the polymerization catalyst contained in the polyester resin is deactivated by such hot water washing treatment and that it is possible to bring the amount of the cyclic trimer into within the above-mentioned range efficiently by preventing the cyclic trimer from increasing during melt spinning.

Moreover, spinning workability is improved because no cyclic trimer is deposited on a spinneret, and it is desirable because no fluff is formed.

The difference between the content of the cyclic trimer of a polyester after melt-extruding a polyester component in a spinning step and the content of the cyclic trimer of a polyester to be fed into melt-spinning is preferably less than 0.3%, and more preferably less than 0.2%.

Within such a range, spinning workability is improved and a resulting fiber can be inhibited from generation of fluffs. It is assumed that the spinning workability is improved and generation of fluffs is reduced because the polymerization catalyst contained in the polyester has been deactivated and therefore the cyclic trimer has not increased through the melt-spinning process. When outside that range, thread breakage may often occur in spinning and thread breakage may occur frequently in a weaving/knitting process due to a large amount of fluffs in a resulting conjugate fiber.

Next, one example of a step for producing a polishing fabric using the splittable conjugate fiber of the present invention is described.

A splittable conjugate fiber obtained in a manner described above is woven or knitted into a fabric and then the polyester component and the polyamide component are split from each other mechanically or chemically.

As a preferable splitting method, a method in which a splittable conjugate fiber composed of a polyester and a polyamide is swollen with benzyl alcohol to cause the polyamide to shrink is desirable because a raising feeling suitable for polishing or cleaning can be obtained uniformly.

Another desirable splitting method is to peel the polyester component from the polyamide component physically by giving a false twist with a false twister.

In the case of a fabric for polishing, a texture tape can be obtained by cutting the fabric into an appropriate tape state. As to a fabric for cleaning, the fabric can be processed into an appropriate shape.

### Examples

The present invention will be described in more detail with reference to Examples. The characteristic values provided in the following examples are values measured by the methods given below.

### (1) Intrinsic Viscosity of Polyester

The intrinsic viscosity [η] was measured by a conventional method in a mixed solvent of phenol/tetrachloroethane=6/4 (weight ratio) at 20° C. using an automatic viscometer.

### (2) Relative Viscosity of Polyamide

The relative viscosity ηrel was measured by a conventional method in a sulfuric acid solvent at 20° C. using an Ostwald viscometer.

### (3) Content (CT) of Cyclic Trimer

After a polyester chip or a polyester resin resulting from melt extrusion was dissolved in a hexafluoroisopropanol:chloroform=1:1 solution, acetonitrile was added to precipitate a polymer. The filtrate was quantified by high performance liquid chromatography using methanol as a mobile phase.

The CT of a polyester chip after polycondensation was made as CT1, and the CT of a polyester chip after hot water treatment was made as CT2. The CT of a polyester resin after being melt-extruded in a spinning step was made as CT3. The CT contained in a splittable conjugate fiber is expressed by this CT3.

### (4) Breaking Strength and Elongation at Break

A tensile test was performed until breakage was occurred by using an autograph tensile tester (manufactured by Shimadzu Corporation) at an initial length of 200 mm, a strain rate of 100%/min and an initial load of 1/30 cN/dtex, and the breaking strength and the elongation at break were determined.

### (5) Spinning Workability

A sample with a spinning full package yield of 90% or more, a sample with a spinning full package yield of less than 90%, and a sample with a spinning full package yield of less than 80% were evaluated as “∘”, “Δ” and “×”, respectively.

### (6) Wiping Cloth Performance

A tape-shaped fabric was produced using a splittable conjugate fiber as weft, and polishing/cleaning evaluation was performed. A sample with good performance was evaluated as “∘”, and a sample incapable of being used was evaluated as “×”.

### Example 1

A polyester chip (PET: polyethylene terephthalate) having an intrinsic viscosity of 0.635 was obtained by an ordinary direct continuous polymerization method with use of germanium dioxide as a polymerization catalyst but without adding titanium dioxide. The content (CT1) of a cyclic trimer in this polyester chip was 1.20%. Next, this polyester chip was preliminarily crystallized and then was subjected to hot water treatment with hot water of 100° C. for 3 hours. Thus, a polyester chip having a content (CT2) of a cyclic trimer of 0.88% was obtained. The resulting polyester chip was dried to a moisture content of 20 ppm and then was melt-extruded at 295° C. to introduce into a spinneret. The content (CT3) of the cyclic trimer of the discharged polymer was measured to be 0.86% and (CT3-CT2) was 0.02%.

On the other hand, a Nylon 6 chip having a relative viscosity of 2.70 and a titanium dioxide content of 0% was melt-extruded at 280° C. and was discharged through the spinneret forming a cross-sectional profile shown in FIG. 1(c) after being united with the polyester within the spinneret. Then, a 56 dtex/25 f splittable conjugate fiber filament was wound up by a direct spinning-drawing process.

The breaking strength, the elongation, the spinning workability, and the fluff generation state of the resulting splittable conjugate fiber were as given in Table 1.

Then, a fabric for wiping cloth was obtained by weaving with use of this conjugate fiber as weft and with use of a 84 dtex/36 f polyester fiber produced from the above-mentioned polyester chip as warp.

The fabric was subjected to a chemical treatment and then the polyester component and the nylon component were split. Thus, a tape-shaped high density microfiber fabric was obtained. The resulting fabric was impregnated with isopropanol and a glass plate was wiped therewith. Based on the amount of a white powder formed, the wiping cloth performance was evaluated to find out that it was satisfactory.

### Example 2

A splittable conjugate fiber was obtained in the same manner as in Example 1 except for spinning out a 122 dtex/100 f conjugate fiber by using a polyester chip given in Table 1. The performance and physical properties of this splittable conjugate fiber were good as given in Table 1.

### Example 3

A 122 dtex/100 f splittable conjugate fiber filament was spun out using a polyester chip given in Table 1. The content (CT3) of a cyclic trimer of the resulting splittable conjugate fiber was within the range of the present invention, and precise polishing was performed successfully without scratching an object to be polished. However, because the difference between the content (CT3) of the cyclic trimer after melt extrusion and the content (CT2) of the cyclic trimer after hot water treatment was greater than 0.3%, a fluff became prone to be slightly generated and therefore the fiber was poorer in spinning workability in comparison to Examples 1 and 2, although spinning could be carried out.

### Comparative Example 1

A 122 dtex/100 f splittable conjugate fiber filament was spun out using a polyester chip given in Table 1. This conjugate fiber filament had fluff generation and was poor in spinning workability. Comparative Example 1 was poor in wiping cloth performance because the CT3 was large and objects to be polished might be scratched.

### Comparative Examples 2 and 3

In Comparative Example 2, a polyamide component being the same as that used in Example 3 was used and a polyester chip containing 0.032% of titanium dioxide was used as a polyester component.

In Comparative Example 3, a 56 dtex/25 f splittable conjugate fiber filament was spun out by using a polyester component being the same as that used in Example 3 and using Nylon 6 having a titanium dioxide content of 0.21% and a relative viscosity of 2.90 as a polyamide component.

Both products had no problems with respect to spinning workability or fluff generation state, however, they were unsuitable for polishing hard disks made of glass at high precision because they scratch hard disk surfaces due to their inclusion of titanium dioxide.

### Example 4

A splittable conjugate fiber filament was spun out in the same manner as in Example 1 except for using a polyester chip prepared by subjecting a polyester chip having an intrinsic viscosity [η] before hot water treatment of 0.635 to solid phase polymerization and then performing hot water treatment, and setting the melt extrusion temperature of the polyester component at 305° C. Although spinning was possible, the spinning workability was poorer in comparison to Examples 1 to 3 because degradation of the Nylon 6 component occurred due to a high spinning temperature of the polyester component.

TABLE 1

| | Examples | | | Comparative Examples | | | Example |
|---|---|---|---|---|---|---|---|
| | 1 | 2 | 3 | 1 | 2 | 3 | 4 |
| TiO₂ content (%) of | 0 | 0 | 0 | 0 | 0.032 | 0 | 0 |
| polyester component | | | | | | | |
| TiO₂ content (%) of | 0 | 0 | 0 | 0 | 0 | 0.21 | 0 |
| polyamide component | | | | | | | |
| PET [η] | 0.635 | 0.635 | 0.637 | 0.635 | 0.629 | 0.635 | 0.710 |
| CT1 (%) | 1.20 | 1.50 | 1.8 | 1.8 | 1.2 | 1.20 | 0.40 |
| CT2 (%) | 0.88 | 0.90 | 1.2 | 1.3 | 0.9 | 0.88 | 0.37 |
| CT3 (%) | 0.86 | 0.90 | 0.8 | 1.1 | 0.9 | 0.86 | 0.37 |
| CT3 − CT2. | 0.02 | 0 | 0.4 | 0.2 | 0 | 0.02 | 0.0 |
| Breaking strength (cN/dtex) | 4.94 | 4.35 | 4.28 | 4.33 | 4.34 | 4.84 | 4.75 |
| Elongation at break (%) | 38.6 | 35.6 | 36.2 | 36.2 | 37.1 | 39.2 | 33.1 |
| Spinning workablity | ◯ | ◯ | X | X | ◯ | ◯ | X |
| Fluff generation | ◯ | ◯ | X | X | ◯ | ◯ | ◯ |
| Wiping cloth performance | ◯ | ◯ | ◯ | X | X | X | ◯ |

1. A splittable conjugate fiber which contains substantially no titanium dioxide and which is composed of a polyester component and a polyamide component, wherein the content of a cyclic trimer contained in the polyester component is less than 1.0%.

2. A method for producing a splittable conjugate fiber composed of a polyester component and a polyamide component, wherein melt-conjugate spinning is performed by using, as a raw material of the polyester component, a polyester chip having a content of a cyclic trimer contained in the polyester component of less than 1.0%, so that the difference between the content of the cyclic trimer contained in the polyester after melt extrusion and the content of the cyclic trimer contained in the polyester chip is less than 0.3%.

3. The method for producing a splittable conjugate fiber according to claim 2, wherein, as the polyester chip, a product prepared by subjecting a polyester chip resulting from melt polycondensation to water-washing treatment with hot water to deactivate a polycondensation catalyst contained in the polyester is used.
